(19) United States
(12) Patent Application Publication
(10) Pub. No.: US 2026/0343445 A1
(43) Pub. Date: Oct. 29, 2026

(54) CONTACT FREE CALIBRATION

(71) Applicant: Net Insight AB, Solna (SE)

(72) Inventors: Michael ANDERSSON, Österskär (SE); Paul DREIK, Nacka (SE)

(73) Assignee: Net Insight AB, Solna (SE)

(21) Appl. No.: 19/107,406

(22) PCT Filed: Aug. 30, 2023
(86) PCT No.: PCT/EP2023/073814

§ 371 Date: Feb. 27, 2025

(30) Foreign Application Priority Data
Aug. 30, 2022 (SE) 2251003-6

(51) Int. Cl. H04W 56/00; H04B 17/00

(52) U.S. Cl. CPC H04W 56/0015; H04B 17/0085; H04W 56/006

(57) ABSTRACT

The present invention relates to a method and device for enabling contact free local calibration of a time dependent device (N1) using a mobile calibration unit (MCD) which is provided with a local reference clock. The method comprises moving the MCD within a predetermined distance from N1 (S105B) and establishing temporary time transfer sessions for transmitting and/or receiving timing signals of local clock of N1 and RC (S101A, S101B, S101C), and determining a timing data offset between the local clock of N1 and RC (S103) for use when calibrating or verifying a timing feature of N1 (S104).

### TECHNICAL FIELD

The present invention relates to the field of calibration of time dependent devices and nodes. More particularly, the proposed technique relates to a method and device and for providing contact free calibration of a timing feature of a time dependent device or node.

### BACKGROUND OF THE INVENTION

Network synchronization, i.e., synchronization between nodes in a network, is often essential for functions within the network. For example, packet-based networks may require frequency and time synchronization (phase alignment) between nodes for successful packet transfer, where operators may provide synchronization services to their customers. For telecommunication, such as in a wireless telecommunication network, the network nodes need to be synchronized with each other, where after terminals in the network synchronize to respective network nodes. As an example, in the implementation of the radio access technology New Radio (NR) for realizing 5G communication, a terminal will be connected to several base stations or network nodes for enabling communication. Hence, the need for network synchronization between the different nodes in networks, such as e.g., base stations in 5G for time dependent applications in many industries, including media, finance, automation, power grids and mobile networks, but also in many other areas, has increased. Synchronization measurements may include phase measurements in view of reference signals, phase deviation and analysis of the phase time interval error, fractional frequency offset, maximum time interval error (MTIE) and time deviation (TDEV).

The task of network synchronization in a network-based approach comprises to distribute a reference signal from a primary reference clock (PRC) to all network elements requiring synchronization. The method used for propagating the reference signal in the network is usually the master-slave method, a hierarchical model where the slave clock must be slaved to a clock of higher (or equal) stability. Synchronization information is transmitted through the network via synchronization network connections. Synchronization network connections typically are unidirectional and generally point-to-multipoint. A centralized timing network architecture may be used, or a distributed timing network architecture (e.g., GPS).

A GNSS, or Global Navigation Satellite System, is a generic name for a group of artificial satellites that send position and timing data from their high orbits. GNSS provides basic technology for time synchronization master to enable global distribution of a Universal Time Coordinated (UTC) traceable reference. The Global Positioning System (GPS) is just one of the many different sets of satellites that can provide such data. GPS or other GNSS satellites include three or four atomic clocks that are monitored and controlled to be highly synchronized and traceable to national and international standards, i.e., UTC. For time synchronization, the GPS signal is received, processed by a local master clock, time server, or primary reference, and passed on (distributed) to “slaves” and other devices, systems, or networks so their “local clocks” are likewise synchronized to UTC. Typical accuracies range from better than 1 microsecond to a few milliseconds depending on the synchronization protocol. It is the process of synchronization to GPS that can provide atomic clock accuracy without the need for a local atomic clock. Still, local atomic clocks are sometimes desired as a long-term back-up solution to loss-of-GPS, either in the case or a weather-related outage, GPS interference, or other scenarios.

Time transfer (relative and absolute) describes mechanisms for comparing measurements of time and frequency from one location to another. Time transfer is a scheme where multiple sites share a precise reference time. Multiple techniques have been developed for transferring reference clock synchronization from one point to another, often over long distances. Time transfer may be used for time synchronization between different entities or nodes in a network, which is essential for the function of the network.

In a one-way time transfer system, one end transmits its current time over some communication channel to one or more receivers. The advantage of one-way systems is that they can be technically simple and serve many receivers, as the transmitter is unaware of the receivers. The principal drawback of the one-way time transfer system is that propagation delays of the communication channel remain uncompensated except in some advanced systems.

In a two-way time transfer system, neighboring nodes will both transmit and receive each other's messages, thus performing two one-way time transfers to determine the difference between the remote clock (neighboring clock) and the local clock. The sum of these time differences is the Round-Trip-Time (RTT) between the two nodes. It is often assumed that this delay is evenly distributed between the directions between the peers. Under this assumption, half the RTT is the propagation delay to be compensated for when estimating delay compensation. A drawback is that the two-way propagation delay must be measured and used to calculate a delay compensation/correction. To calculate correct delays and determine compensation, information such as time stamps, time difference measurements, correction factors, and various statistics between nodes involved in two-way time transfer need to be available.

Usually, network-based distribution is performed from one or several central sites to a large number of destination sites. The communication node-to-node can be done either over the air or wire. In a network having several paths, redundancy can be implemented. However, as the number of hops between the node and the clock source node increases, accuracy becomes lower by the number of hops passed due to jitter because of other traffic. In addition, asymmetrical delays affect the accuracy and for some applications, the accuracy is not simply good enough.

Two-way time transfer mechanism is the basis of all packet time transfer protocols, such as Network Time Protocol (NTP) and IEEE 1588, Precision Time Protocol (PTP). They generally assume path symmetry and path consistency, although IEEE 1588 has the concept of asymmetry correction. However, the correction values are not dynamically measured-they need to be statically configured, i.e., by calibrating the node with respect to a required timing feature such as in this case asymmetry.

FIG. 1 is a schematic illustration of an exemplary prior art network. The network 5 here schematically illustrates a typical 5G mobile network and comprises a radio access network (RAN) with a split logical architecture. In such a RAN the functionalities in the RAN domain are governed by groups of radio units (RU) which connect to respective distributed units (DU). The DUs are in turn typically associated with a centralized unit (CP). In the exemplifying network 5 two RUs 60, each serving a respective cell, are associated with a DU 70. The DU 70 may communicate with a CP (not shown). Connected to the RAN 5, a transport network 80 is formed by a multiple of interconnected routers 81 and in turn form the transport domain 40. The transport network 80 may support PTP (or some other time transfer protocol). Synchronization methods to provide appropriate frequency synchronization and time alignment of a radio network such as the RAN 5 may be implemented in the RAN domain 30, the transport domain 40 or as a combination of techniques in both domains, which may be required to create a robust and reliable solution. In prior art, synchronization methods like utilizing GNSS and over-the-air synchronization (OAS) may be implemented in the RAN domain 30. That is, a relative time/timing error between neighboring base stations, RU 60, may be compensated for using e.g., OAS, which is schematically illustrated in FIG. 1 with arrow 61. Synchronization methods implemented in the transport domain 40 typically requires utilizing PTP and other timing support from the network to meet the relevant time synchronization requirements. Preferably, the PTP network is fed from geographically redundant telecom grandmasters (T-GMs) 91, 92 or GNSS receivers and T-GM functionality in one or more base stations (RU 60 or DU 70) or routers 81. By distributing timing over the same physically redundant topologies that are used for user traffic, redundancy may be achieved. In FIG. 1 DU 70 is further provided with a local GPS receiver 10b which receives time from a GPS 10a. Distribution of timing over the transport network can be provided as a complement to such a local GPS receiver.

Using a GNSS receiver such as a GPS receiver which is physically connected to the site is the most common technique today for calibration/synchronization of a site. This common way for providing accurate time and frequency synchronization is performed by obtaining accurate clocks from GPS and other GNSS systems directly into nodes in the communication network, e.g., by installing GPS receivers at transmitter sites. Although GPS will deliver the required accuracy to the GPS receivers, they may however be easily intentionally or unintentionally jammed, or fail for other reasons such as equipment failure which makes this method unreliable due to its vulnerability to interference or jamming.

Having GNSS/GPS systems as the main and only source for synchronization or calibration of time in a node in a network thus constitutes a major risk in critical infrastructure and is not permitted in many countries.

In order to maintain time synchronization between the nodes like e.g., base stations in a telecommunication network, such as the one illustrated in FIG. 1, the base stations can be synchronized to each other or synchronized to a common time base, e.g., to GPS system time. Typically, every base station must be individually calibrated with special test equipment after the base station installation is complete.

The result of this calibration process is a time offset for the local time of each base station e.g., with respect to the time base. The time offsets are stored in a data base accessible during the computation of time dependent variables in the network. Any subsequent hardware change in a base station necessitates re-calibration of the base station and updating of the data base. Calibration and re-calibration of the nodes in a network represents a costly process.

An important and widespread problem in time and frequency transfer methods is how to handle asymmetry, meaning the transmission delay is different in the receiving and transmitting direction between a source and target. In a time transfer network, local clocks of the base stations or network nodes can be calibrated link by link by measuring individual link delays based on the local clocks and RTT. However, most known protocols for delivering time synchronization assume that the link delay is equal to RTT/2 and have difficulties in handling asymmetric delays, i.e., where the delay from a first Node A to a second Node B is different than the delay from the second Node B to the first node A. If this is a static delay this can be calibrated and handled thereafter. Asymmetry may also occur dynamically during operation and is something that break many two-way time transfer protocols and thus there is a need to at least improve the ability of handling such asymmetry of delays.

Conventional calibration of a node in e.g., telecommunication networks may involve physical access to a Telecom company (Telco) site including access to outdoor structures, e.g., the top of the cell tower, or inside of buildings, cabinets, and the like. With a high number of Telco sites which are geographically distributed calibration at the Telco sites can be expensive and complex. On site calibration with physical cabling is further costly and time consuming e.g., because it may require staff to be equipped with keys and/or other means to access the equipment.

Telco's sometimes have the option to use Over Air Synchronization (OAS) where radio transmitters at respective, typically neighboring Telco sites exchange timing information over air. OAS typically considers frequency-and not absolute time and phase synchronization/calibration. Since air can be assumed to have no asymmetries over short distances an already calibrated Telco site can use OAS to calibrate another Telco site within reach. This however means that any calibration errors will accumulate when multiple sites are calibrated one after the other in a chain. A problem with using OAS is that these systems are dependent on satellite-based clock signals (GPS/GNSS), which signals can be jammed and spoofed. In addition, OAS demands built-in functions in the Telco equipment. Moreover, often each vendor has locked to proprietary solutions even if following standard.

In conclusion, there is a need for enhanced methods for calibration of nodes and network synchronization in communication networks.

### SUMMARY OF THE INVENTION

An object of the present disclosure is to provide methods, nodes and systems, which seek to mitigate, alleviate, or eliminate the above-identified deficiencies and disadvantages in the art singly or in any combination. It is a further object to simplify calibration and/or verification of freestanding time dependent devices which are not connected to a network, as well as nodes in a network, such as e.g. nodes in 5G networks, to minimize physical access to the freestanding time dependent device or to the nodes in the network, which reduces time for calibration, is beneficial for security, and also enables calibration of devices or nodes in cases when physical access is limited or undesired due to radiation, biological hazards etc. The invention can also be used in areas where calibration using GNSS is not possible due to jamming, spoofing, out-of-sight, or because of cost concerns.

The inventive concept concerns a device and methods for enabling calibration or validation of timing features in a device or a node in a network, such as for example in radio communication networks. This is achieved by providing a temporary, wireless or contact-free, trusted reference clock locally by means of a mobile calibration device (MCD) to be used as a timing reference of the local clock of the device or node. This is advantageous when performing calibration of a timing feature and optionally to provide synchronization between nodes in a network.

In addition, providing a site or a device with the temporary or continuous support of the timing reference from the MCD, can advantageously be utilized to provide a time/phase/frequency source to the site itself, sub part of the network and/or the entire network. This is useful when the main clock site is broken, or a clock path to the main clock site is broken, or any other possible failure or disturbance making it advantageous or necessary to flip/reverse the direction of time/phase/clock distribution or to move the responsibility of acting as a trusted clock source from one site to another site.

According to a first aspect of the inventive concept, there is provided a method for calibrating a time dependent device, N1, with respect to a timing feature using a mobile calibration device, MCD. The method comprises providing the MCD with a reference clock, establishing at least one time transfer session between the MCD and N1 and/or a common time reference (CTR). According to an embodiment, it may further comprise comparing timing data of the reference clock and timing data from N1, determining a timing data offset between N1 and MCD, and calibrating or validating the timing feature of N1 based on the determined the timing data offset.

The reference clock or reference time of the MCD may be transported to N1 using a temporary time transfer session, which is set up with a known asymmetry or negligible asymmetry, such that a delay in both directions over the established link path between the MCD and N1 is exactly (or sufficiently near to) RTT/2. Such calibration of N1 either makes the local time of N1 to have nominally zero offset with respect to the trusted source (the reference time/clock) or have a known offset with respect to the trusted source, which N1 may then use to compensate for or calibrate timing features such as e.g., any offsets in time information of data streams received and transported by N1 in a network.

According to an embodiment, the time dependent device is a node in a network and may one of a mobile base station, time transfer device, digital TV/Radio-transmitter, power station in smart grid, a data communication equipment, a data terminal equipment, and a time dependent equipment.

According to an embodiment, the method further comprises moving the MCD within a predetermined distance, D, from N1. The predetermined distance may be selected to provide a known or negligible asymmetry in transmission time in both directions for data transmission between N1 and MCD or may be determined based on the technology used for setting up the temporary time transfer session between the MCD and N1, i.e., a wireless communication link or measurement means used for communicating with N1.

According to an embodiment, the time transfer session is a one-way time transfer session or a two-way time transfer session.

According to an embodiment, the time transfer session is performed using a wireless communication link or measurement means of contact free type of said MCD.

According to an embodiment, the method further comprises determining the predetermined distance. This may be performed based on the used wireless communication link or measurement means. The predetermined distance may alternatively be pre-configured, received via a central node, determined by measuring a signal strength in the time transfer session or a test signal used when approaching N1, acquired using previous experience or be determined via lookup table.

According to a second aspect there is provided a mobile calibration device, MCD, for calibrating a time dependent device, N1, with respect to a timing feature. The MCD comprises a wireless communication interface for local data transmission between said MCD and N1, a reference clock, processing circuitry including a memory and a processor configured to enable the steps of establishing a time transfer session between said MCD and N1 via said wireless communication interface and providing timing information from the reference clock to N1.

According to an embodiment of the MCD, the processing circuitry is further configured for: comparing timing data of the reference clock with timing data received from N1, determining any timing data offset between N1 and MCD, and storing timing data of the time transfer session and/or transmitting the timing data offset for calibration of the timing feature of N1 based on the determined timing data offset.

According to an embodiment of the MCD, it further comprises a global navigation satellite system, GNSS, receiver for providing the reference clock, According to an embodiment of the MCD, the wireless communication interface is configured for transmitting and/or receiving signals containing timing data for local data transmission between said MCD and N1.

According to an embodiment of the MCD, the wireless communication interface comprises one of an optical receiver, transmitter or transceiver, an audio receiver/transceiver, radio receiver, transmitter or transceiver.

According to an embodiment of the MCD, the MCD is a vehicle, an unmanned aerial vehicle or a carrying equipment.

According to the invention, the timing feature is preferably one of a time-, phase-, frequency-, absolute time-, and asymmetry offset.

A node or device as referred to herein is selected as one of a 5G base station, gNode B, 5G small cell, eNode B, Node B, digital TV-transmitter, power station in smart grid, a data communication equipment, a data terminal equipment, a time dependent equipment, a TV-, radio-media production device and/or network, a military device, a sensor station, a radar station, or a free-standing group of time dependent equipment joined in an isolated network

In other aspects are provided a computer program comprising computer program code which, when executed in a network node or device, causes the network node or device to execute the methods described above. In yet another aspect, a carrier containing the computer program is provided, wherein the carrier is one of an electronic signal, optical signal, radio signal, or computer readable storage medium.

Further objective of, features of, and advantages with, the present invention will become apparent when studying the following detailed disclosure, the drawings, and the appended claims. Those skilled in the art realize that different features of the present invention can be combined to create embodiments other than those described in the following.

### BRIEF DESCRIPTION OF THE DRAWINGS

The above, as well as additional objects, features, and advantages of the present invention, will be better understood through the following illustrative and non-limiting detailed description of preferred embodiments of the present invention, with reference to the appended drawings, where the same reference numerals will be used for similar elements, wherein:

FIG. 1 is a schematic illustration of a typical network configuration and calibration/synchronization in prior art.

FIGS. 2a and 2b illustrate embodiments of the inventive concept for contact free local calibration of a time dependent node using a mobile calibration device (MCD) implemented in an example network as illustrated in FIG. 1.

FIGS. 3a and 3b illustrate embodiments of the inventive concept for contact free local calibration of a node using a MCD implemented in an example network as illustrated in FIG. 1.

FIG. 4 illustrates an embodiment of the inventive concept for calibrating a node using a MCD implemented in an example network as illustrated in FIG. 1.

FIG. 5 shows a flowchart of an exemplary method for calibrating a device or node using a MCD according to embodiments of the present inventive concept.

FIG. 6 is a schematic block diagram of an example device of the inventive concept. All the figures are schematic, not necessarily to scale, and generally only show parts which are necessary in order to elucidate the invention, wherein other parts may be omitted or merely suggested.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout. The terminology used herein is for the purpose of describing particular aspects of the disclosure only and is not intended to limit the disclosure. As used herein, the singular forms “a”, “an” and “the” are intended to include the plural forms as well, unless the context clearly indicates otherwise.

In some embodiments herein a non-limiting term “node” or “network node” is used. It should be understood that this term refers to any type of node that may send and/or receive information, such as data and control information, over a network. The node may sometimes also be referred to as a “station” or “base station” when applicable. The node may also be referred to as a “site”, or present at a site. A physical node is typically an electronic device that is attached to a network, and is capable of creating, receiving, or transmitting information over a communications channel. The node may be a node in a 5G wireless communication network, such as a 5G network node, a 5G macro cell (e.g., gNB) or 5G small cell. The network node may also be a 4G sector base station (e.g., eNB) for use in 5G communications. The node may be a node in machine to machine (M2M) communication, e.g., a machine type communication (MTC) node for realizing massive MTC and Internet of things (IoT) applications, or a node in a e.g., a vehicle-to-everything (V2X) application for enabling Ultra-reliable low latency communications (URLLC). The node may also be a node for use in enhanced 5G mobile broadband (eMBB) applications, providing significantly faster data speeds and greater capacity than previous mobile broadband applications. New applications will include fixed wireless internet access for homes, outdoor broadcast applications without the need for broadcast vans, and greater connectivity for people on the move. A node to be calibrated according to the inventive concept may also be a TV transmitter, encompass a data communication equipment (DCE) such as a modem, router, hub, bridge, controller, or switch; or data terminal equipment (DTE) such as a digital telephone handset, a printer or a host computer. In another example the node may be a computer terminal connected to a network, such as a local area network (LAN), wide area network (WAN) or the Internet. In yet another example, the node may be a phasor measurement unit (PMU) in a power system.

It should be understood that the present inventive concept is applicable for calibrating and/or validating a solitary, free standing time dependent device which is not connected to a communication network or other network. Examples of free standing time dependent devices are light houses, free standing atomic clocks, nuclear facilities, military devices (optionally in an air gapped network), surveillance camera/equipment, equipment in financial trading systems or other types of devices where connectivity to a communication network or the like is not possible for practical or security reasons.

The term “network” refers to any type of network over which a network node may communicate, such as a radio access network (RAN), a local area network (LAN), wide area network (WAN) or the Internet. The RAN may be a wireless communication network for enabling 5G, e.g., implementing NR. The network may be referred to as an Internet Protocol (IP) network, a communication network that uses IP to send and receive messages between one or more computers, which may be implemented in Internet networks, LAN, and enterprise networks, for example. The network can serve 5G or a digital television (DTV) distribution network operating in single frequency network (SFN) operation. According to embodiments of the inventive concept the term network concerns a power grid network, an isolated network, or any applicable network.

The term “local clock” in view of a certain node, station or other time dependent device is meant a clock that is present in/at said node, station, or device. With a “remote clock” in view of a certain node is meant a clock that is not present in/at said node, but present at another node/station remotely located from the said node/station. With a “high quality clock” is meant a clock that have low intrinsic timing errors, and which is able to keep the time without drifting, such as atomic clocks. A rubidium atomic clock is typically used as a high-quality clock. The clocks may show wrong time or correct time. A clock showing a wrong time may also be referred to as inaccurate or incorrect, such as an inaccurate or incorrect clock. A clock showing the correct time may also be referred to as accurate or correct, such as an accurate or correct clock.

The system of the invention, and nodes and methods performed therein, are primarily intended to be used for a robust calibration or validation of time dependent devices or nodes in radio communication networks or similar and is applicable to any network having time aware nodes. 5G networks have been exemplified herein since they are generally dependent on exact time, both due to the requirements on timing and latency, and due to the use of multiple base stations in the RANs, where multiple base stations are connected at the same time to a terminal, device, user equipment (UE) or mobile station. A UE may be served by multiple base stations at the same time, potentially both 5G base stations and LTE base stations, such as gNBs, eNBs or NBs, and 5G small cells or nodes for Massive MTC (smart devices, buildings, meters) or critical MTC (traffic control, industry control or remote surgery). 5G have different modes of operation, with one of the most demanding ones, 5G CoPM, being a combination of CoMP and MIMO (multiple input multiple output), i.e., multiple access points using several antennas, requiring 100 ns accuracy for the clock/timing.

The invention will now be described with reference to various embodiments implemented in a system of the invention.

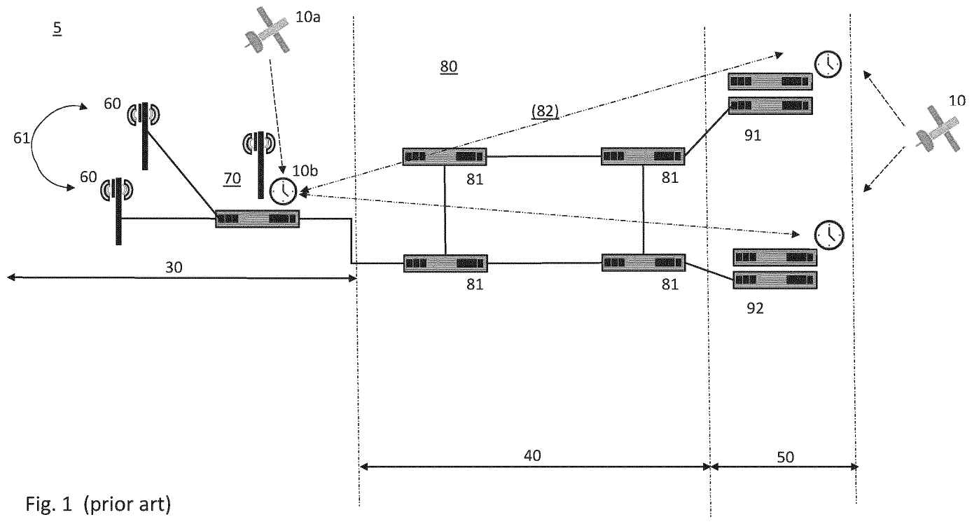

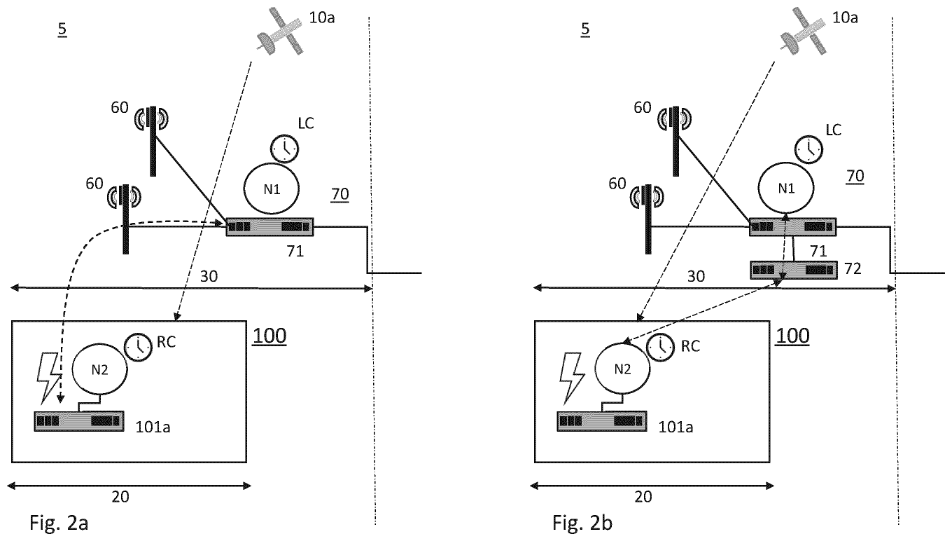

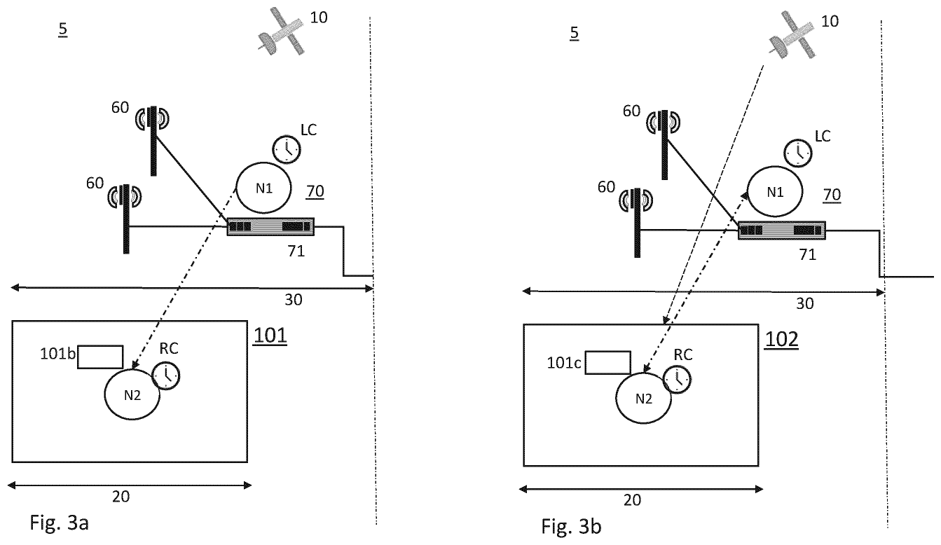

With reference now to FIGS. 2a-2b and 3a-3b , the RAN domain 30 of the prior art RAN 5 which was described in the schematic illustration of FIG. 1 is used as an example in which embodiments of the inventive concept described herein are implemented.

In the examples shown herein DU 70 represents node N1 to be calibrated by using a MCD (100-102). N1 is physically positioned at a cell site 20 (Telco User domain) of the telecom provider that controls the node N1. N1 has a local clock (LC), and a radio modem 71.

The MCD 100 is a mobile device, such as a vehicle, an unmanned aerial vehicle, e.g., a drone or a radio-controlled helicopter, or a carrying equipment. The type of vehicle may be selected based on the telco site and node. When serving base stations as in the examples given herein, a drone is a suitable vehicle which allows the MCD to be remotely controlled to move to different base stations for providing contactless local calibration or validation of N1. The MCD 100 is here equipped with a wireless communication interface, radio modem 101a, for providing local data transmission between the MCD and N1, a local reference clock (RC) including a GPS receiver to provide a trusted reference time from the GPS 10a, and processing circuitry (not shown) configured to enable the steps of establishing a time transfer session between the MCD and N1 via the modem 101a and modem 71 of the DU 70 via RU 60 as illustrated in FIG. 2a or via a dedicated radio modem 72 arranged at or in connection to N1 as illustrated in FIG. 2b. The time transfer session initiates an exchange of timing features of the MCD 100 and the DU 70, e.g., time stamps of the local time LC of N1 and the reference time RC. The processing circuitry is further configured for: comparing timing data of the reference clock with timing data received from N1, determining any timing data offset between N1 and MCD, and optionally storing timing data of the time transfer session and/or transmitting to the site or controller of the site the timing data offset for calibration of N1 based on the determined timing data offset. The comparison of the timing data may include e.g., comparing the clock phase of the reference clock, RC, and the local clock on N1, LC. The calibration or updating of LC may be handled via any available management path of the node N1.

The radio modems 101a, 71, 72 are used to transmit data over shorter or longer distances on their own frequencies, which may be free frequencies or frequencies that require a license/permit. The time transfer session may be set up on a dedicated channel.

In an embodiment, the wireless communication interface comprises at least one of an optical receiver, transmitter or transceivers, an audio receiver, transmitter or transceiver, a radio receiver, transmitter or transceiver, or an inductive receiver, transmitter, or transceiver.

According to an embodiment, the wireless communication interface contains an optical receiver/transmitter/transceiver (not shown). In this scenario N1 is equipped with an optical transmitter such as a light source or a laser flashing with a predetermined frequency, e.g., every second (Pulse Per Second-known art), communicating a timing feature such as its perceived clock time by means of an optical signal. MCD comprises an optical receiver that receives the optical signal. The reverse situation is also applicable, where the MCD is also or alternatively arranged with a light source to provide an optical signal containing timing data/time information, e.g., which signals the time reference of the MCD to N1. N1 (also or alternatively) comprises an optical receiver which receives optical signal containing the time reference from the MCD and is further arranged to calibrate its clock time according to the timing data received in the optical signal. In the embodiment when the MCD has an optical receiver, the MCD may further determine an offset between the local time of MCD and N1, store and/or communicate back to N1 its offset from the MCD for N1 to adjust via the communication channel previously described above, i.e., the transmitted and received optical signals. The MCD preferably stays within a predetermined distance, e.g., within signal reach, as long as it needs to verify that calibration was successful.

According to an embodiment, the MCD is arranged to track the geographical location, longitude/latitude ((LON/LAT), of itself and/or of N1. The geographical location of N1 and the MCD is tracked and compared using GNSS or other means such as landscape aware detection etc. Comparing the geographical locations can then be used for adjusting for latency of a one-way communication signal, e.g., a one way optical signal. Tracking and comparing geographical location of the MCD and N1 is advantageous since it enables using slower moving communication signals such as when utilizing audio receiver/transmitter/transceivers as wireless communication interface between the MCD and N1.

In a further embodiment, the wireless communication interface between the MCD and N1 is achieved using inductive receivers/transmitters/transceivers (not shown). The MCD is arranged with a battery and inductive power transfer equipment for transfer of power and data signals without (direct or close) mechanical or electrical contact, e.g., near field wireless transfer. The MCD may be arranged on a vehicle such as a drone or land going vehicle. A remote control or programming of the MCD enables it to visit N1 for recharging of its battery using near field wireless power transfer from an inductive charging pad arranged at N1. By further equipping the MCD and N1, e.g., the inductive charging pad of N1, with a signal generator and/or receiver for transferring data by means of the inductive transfer equipment, verification and/or calibration of N1 using the time reference of the MCD is enabled. The verification and/or calibration is optionally performed simultaneously with recharging the battery of the MCD.

According to an embodiment, both the MCD and N1 have a 4/5G modem or similar. The site and drone connect and measure their relative time offset, thus providing information used for calibrating the site.

According to an embodiment as illustrated in FIG. 3a, instead of receiving a time reference via a GPS receiver, an embodiment of a MCD 101 is provided with a freshly updated stable clock. Updating of the clock is preferably performed in e.g., a docking station to which the MCD returns for recharging/refueling/updates. Further, in the example shown in FIG. 3a, the site node N1 distributes its local time via local radio. The time transfer session is here a one way communication. The MCD 101 moves into position at a predetermined distance of the cell site and receives the radio signal via a radio receiver 101b, compares the received timing data from N1 with the reference time RC from which data the offset of the site node as compared to the reference time RC can be deducted and communicated to a controller. The calibration or updating of LC may be handled via any available management path of the node N1.

According to an embodiment as illustrated in FIG. 3b, the site node N1 and a MCD 102 are both equipped with two way radio (such as Wi-Fi). The MCD 102 can thus measure the time offset of the site node compared to the reference time RC.

According to an embodiment, determining the timing offset/comparison of timing data is performed in a central node. The MCD communicates with the central node transmitting obtained respective timing data of the MC and the uncalibrated device/node.

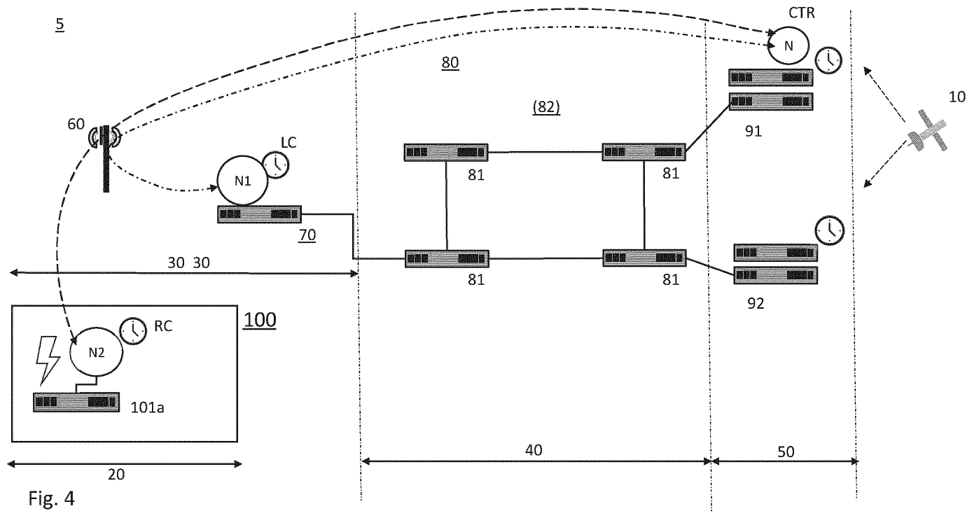

With reference now to FIG. 4, according to an embodiment of the inventive concept the method used herein utilizes that the MCD 100 and the site node N1 both can reach a common time reference (CTR). In the exemplifying example as described with reference also to FIG. 1, the CTR is one of the T-GMs 91, but the CTR may be any common clock reference reachable by the node N1 and by the MCD 100. The MCD 100 establishes a time transfer session to retrieve timing data including timing data of N1 but not by setting up a session directly to the node N1. Instead, a first time transfer session is set up between the MCD 100 and the CTR over the RU 60, and a second time transfer session is set up between the node N1 and the CTR using the same RU 60. The timing data of N1 is then determined by comparing timing data offsets between said reference clock RC and the CTR, and between the local clock of N1 and the CTR. Calibration using a common timing reference is based on that we assume that the MCD and N1 both are able to reach a common timing reference CTR over the same path.

Assume that time errors relative to the master (T-GM 91) are denoted according to the following:

eₗ—absolute time error of N1 (1)

eₘ—absolute time error of MCD (2)

e_{c}—absolute time error of CTR (3)

Assume now that the MCD establishes a time transfer session to CTR, which has a systematic error d. From the time transfer session, we have a measure of a total time error for the MCD, vₘ, equal to:

vₘ=eₘ−e_{c}+d (4)

Now, N1 also establishes a time transfer session to CTR. It is assumed that N1 establishes the time transfer session to CTR with negligible or no difference in transmission characteristics as compared to how the MCD establishes it's time transfer session. For instance, if the MCD and N1 are close to or even at the same location and both use a 4G connection with the same operator there is a high probability that they both use the same radio station, e.g., RU 60 in FIG. 4. Assuming that this is the case, the time transfer session between N1 and the CTR gives a measure of a total time error for N1, vₗ, with the same systematic error d:

v₁=eₗ−e_{c}+d (5)

Given vₘ and v₁, it is now possible to calculate the absolute time error en using equations (4) and (5) which gives:

v₁−vₘ=(eₗ−e_{c}+d)−(eₘ−e_{c}+d)=e₁−eₘ (6)

Since the time error em of the MCD is assumed to be zero or negligible (due to the trusted reference clock),

vₗ−vₘ~=e₁ (7)

Thus, by using a common time reference, the time error, i.e., the timing data offset, of N1 can be found using time transfer sessions to a common timing reference, whose absolute time error is cancelled out. Also, as long as the time transfer sessions share the same systematic error, that systematic error is also cancelled out.

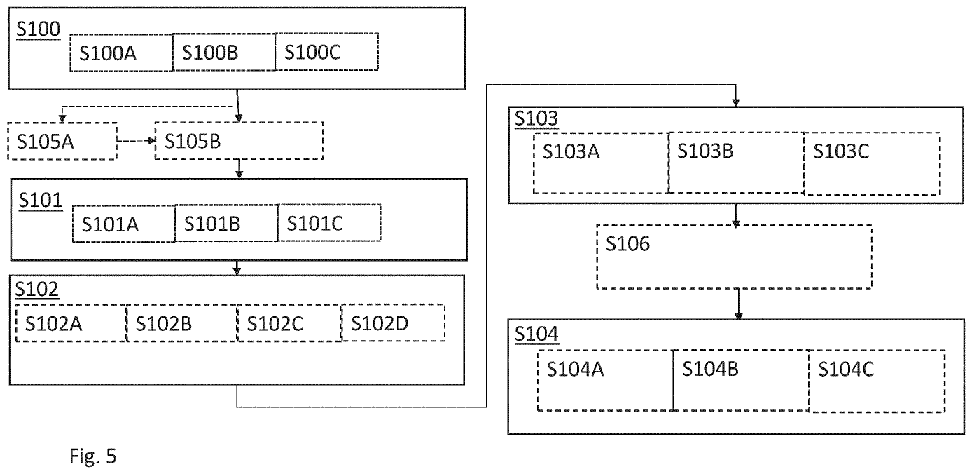

Embodiments of the proposed method according to the inventive concept will now be described in more detail referring to FIG. 5. It should be appreciated that FIG. 5 comprises some operations and modules which are illustrated with a solid border and some operations and modules which are illustrated with a dashed border. The operations and modules which are illustrated with solid border are operations which are comprised in the broadest example embodiment. The operations and modules which are illustrated with dashed border are example embodiments which may be comprised in, or a part of, or are further embodiments which may be taken in addition to the operations and modules of the broader example embodiments. It should be appreciated that the operations do not need to be performed in order, and that different embodiments are covered by the method. Furthermore, it should be appreciated that not all of the operations need to be performed.

FIG. 5 illustrates a method for calibrating a time dependent device or node, N1, with respect to a timing feature using a mobile calibration device, MCD, the method comprising: providing said MCD with a reference clock (S100), establishing a time transfer session (S101), e.g. between said MCD and N1 (S101A). The reference clock may be achieved in different ways, e.g., by using a local clock which has recently been calibrated and is trusted (S100A) or time received via a GNSS receiver (S100B).

The time transfer method may be in one direction, e.g., timing data is sent from the MCD to N1, or from N1 to MCD or be two-way such that timing data is exchanged in both directions. The method further comprises comparing timing data of said reference clock and timing data from N1 (S102). Depending on the flow of timing data, e.g. if a one-way or two-way time transfer session is initiated and in what direction, this step of analyzing the timing data and comparing it can be performed at different positions of the calibration system formed by the MCD (S102A), the device or node to be calibrated (S102B), and optionally another node (S102C), e.g. a centralized node, in the network to which the node is connected. In the same manner, a step of determining a timing data offset between N1 and MCD (S103) and thereby providing the offset value to use when calibrating N1 may be performed:
a) in the MCD (S103A) for sub-sequent (optional) storing (S106) locally or remotely. The offset value may then be communicated to a central node or directly to N1 to perform the calibration of the timing feature of N1 based on the timing data offset (S104A).
b) in the node to be calibrated (S103B), followed by sub-sequent (optional) storing (S106) locally or remotely. The offset value is used when calibrating N1 (S104B), or
c) in a centralized node (S103C) for sub-sequent (optional) storing (S106) locally or remotely. The offset value is used when instructing N1 to calibrate accordingly (S104C).

Before establishing the time transfer session, the method may further include the steps of moving the MCD within a predetermined distance, D, from N1 (S105B) and optionally determining the distance from N1 (S105A) e.g. receiving it from a look up table, base the predetermined distance based on what hardware is used in the wireless communication link/interface or what measurement means of contact free type that is used for setting up the time-transfer session between the MCD and N1, determining the distance adaptively, e.g. by measuring signal strength of the time transfers session or a test signal etc.

As previously described with reference to FIG. 4, a common time reference, CTR, is determined for the N1 and the MCD, and a respective time transfer session is set up between i) said MCD and the CTR (S101B), and ii) between N1 and the CTR, (S101C). When establishing a respective time transfer session between i) said MCD and a common time reference, CTR, and ii) between N1 and the CTR, the timing data of N1 may be determined by comparing timing data offsets between said reference clock and the CTR, and N1 and the CTR (S102D), see equations herein.

Performing calibration is generally described with reference to step S104. N1 is calibrated using the trusted source, i.e., the reference time of the MCD which provides trusted time information to N1. The calibration may be performed directly if the temporary time transfer session involves two-way communication such that the calibration offset can be communicated directly to N1, or if the MCD communicates the reference time to N1 and the analysis of the offset is performed in N1. The calibration offset may also be communicated from the MCD via a link to a node controller in a management network to which both the node N1 and the MCD are connected, or in some other way e.g., by sending the calibration offset to a user for manual update of a freestanding node that is not connected to a network.

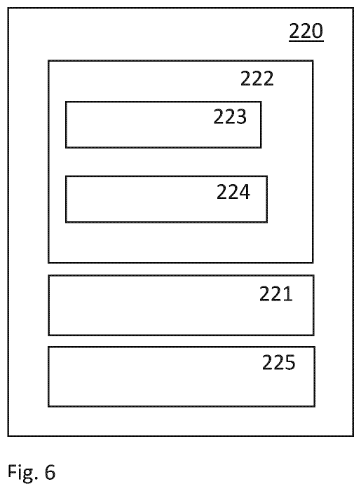

FIG. 6 illustrates a block diagram of a mobile node/calibration device 220 of the invention. The mobile node 220 comprises a wireless communication interface 221 (e.g. a radio communication interface, radio circuitry, network interface or a wireless/contact free measurement means) configured to receive and transmit data communication and/or control signals to and from a device to be calibrated (optionally within a network), e.g. for connecting the mobile node to at least one neighboring node, such as a master or slave node, and/or for sending and receiving data, such as timing data, over transport links, or to measure e.g. optical signals. It should be appreciated that the communication interface 221 is according to some aspects comprised as any number of transceiving, receiving, and/or transmitting units or circuitry. It should further be appreciated that the communication interface 221 can e.g., be in the form of any input/output communications port known in the art. It may comprise RF circuitry and baseband processing circuitry (not shown).

The mobile node 220 further comprises processing circuitry 222 comprising a processor 224 being configured to carry out the method of the invention. The mobile node 220 according to some aspects further comprises at least one memory unit or circuitry 223 that is in communication with the communication interface 221. The memory 223 can e.g., be configured to store received or transmitted data and/or executable program instructions. The memory 223 can e.g., be any suitable type of computer readable memory and can e.g., be of volatile and/or non-volatile type. The memory may for example log received time stamps or actual and/or preferred distance to the node to be calibrated. The processing circuitry 222 is configured to cause the network node 220 to carry out the methods of the invention.

The processing circuitry 222 is e.g., any suitable type of computation unit, e.g., a microprocessor, Digital Signal Processor, DSP, Field Programmable Gate Array, FPGA, or Application Specific Integrated Circuit, ASIC, or any other form of circuitry. It should be appreciated that the processing circuitry need not be provided as a single unit but is according to some aspects provided as any number of units or circuitry. The processing circuitry may thus comprise both a memory 223 for storing a computer program and a processor 224 configured to carry out the method of the computer program. The computer program is e.g., stored in a memory, MEM, 23. The memory 223 can be any combination of a Random Access Memory, RAM, and a Read Only Memory, ROM. The memory 223 in some situations also comprise persistent storage, which, for example, can be any single one or combination of magnetic memory, optical memory, or solid-state memory or even remotely mounted memory.

A controller (CTL) (not shown) or processing circuitry 222 is according to some aspects capable of executing computer program code. It should be appreciated that the processing circuitry need not be provided as a single unit but is according to some aspects provided as any number of units or circuitry.

The mobile node 220 may comprise an internal clock 225 and may be able to provide and store timestamps in relation to said internal clock, and store time stamps in relation to other nodes. The mobile node 220 may comprise or be connected to a GNSS receiver (not shown in FIG. 6).

According to some aspects, the disclosure relates to a computer program comprising computer program code which, when executed, causes a mobile node or device, or a network node to execute the methods described above and below. In other aspects, the disclosure relates to a carrier containing the computer program, wherein the carrier is one of an electronic signal, optical signal, radio signal, or computer readable storage medium.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, nodes, networks, and systems. It should be appreciated that the example embodiments presented herein may be practiced in any combination with each other.

It should be noted that any reference signs do not limit the scope of the claims, and that several “means”, “units” or “nodes” may be represented by the same item of hardware.

Even though the invention has been described in relation to embodiments disclosing certain nodes and networks, it would be possible for the person skilled in the art, based on the present disclosure, to apply the present invention of calibration in any network. The person skilled in the art realizes that the present invention by no means is limited to the embodiments described above. On the contrary, many modifications and variations are possible within the scope of the appended claims. For example, embodiments of the invention may be based on other network technologies than 5G RANs.

1-16. (canceled)

17. A method for contact free local calibration of a time dependent device (N1) using a mobile calibration device (MCD) having a local reference clock (RC) the method comprising:
moving the MCD within a predetermined distance from N1;
establishing at least one temporary time transfer session for transmitting and/or receiving signals containing timing data associated with at least a local clock of N1 and RC;
determining a timing data offset between the local clock of N1 and RC; and
calibrating a timing feature of N1 based on the determined timing data offset.

18. The method according to claim 17, wherein said temporary time transfer session is a one-way time transfer.

19. The method according to claim 17, wherein said temporary time transfer session is performed using a local wireless communication link or measurement means of contact free type.

20. The method according to claim 17, further comprising determining the predetermined distance.

21. The method according to claim 17, wherein the predetermined distance is one of pre-configured, received via a central node, and selected to provide a known or negligible asymmetry in transmission time in both directions for data transmission between N1 and MCD.

22. The method according to claim 20, wherein the predetermined distance determined is determined based on one of the used wireless communication link or measurement means, by measuring a signal strength in the temporary time transfer session or a test signal used when approaching N1, acquired using previous experience, and determined via a lookup table.

23. The method according to claim 17, wherein said at least one temporary time transfer session is set up in any direction between said MCD and N1.

24. The method according to claim 17, wherein said at least one temporary time transfer session is set up by establishing a respective temporary time transfer session between i) said MCD and a common time reference (CTR), and ii) between N1 and the CTR.

25. The method according to claim 24, wherein the step of determining a timing data offset between the local clock of N1 and RC is determined by comparing timing data offsets between RC and the CTR, and N1 and CTR.

26. The method according to claim 17, wherein said temporary time transfer session is a two-way time transfer session.

27. A mobile calibration system for providing contact free calibration of a time dependent device (N1) said system comprising:
a mobile calibration device (MCD) comprising
a wireless communication interface or contact free measurement means configured for transmitting and/or receiving signals containing timing data for local data transmission between said MCD and N1, and
a reference clock; and
a control unit comprising processing:
circuitry including a memory and a processor configured to perform the steps according to a method of claim 17.

28. The MCD according to claim 27, wherein said MCD further comprises a global navigation satellite system (GNSS) receiver for providing said reference clock.

29. The MCD according to any of claim 27, wherein said wireless communication interface or contact free measurement means comprises at least one of an optical-, audio-, radio- or inductive-receiver, transmitter, or transceiver.

30. The MCD according to any of claim 27, wherein the MCD is a ground vehicle, watercraft, aerial vehicle or a carriable equipment.

31. The MCD according to any of claim 27, which is further arranged for tracking a geographical location, longitude/latitude (LON/LAT), of itself and/or of N1.

32. A computer program comprising computer program code which, when executed in a network node or device, causes the network node or device to execute the methods according to claim 17.
